(19) United States
(12) Patent Application Publication
(10) Pub. No.: US 2007/0146393 A1
(43) Pub. Date: Jun. 28, 2007

(54) System and method for re-sizing objects

(75) Inventors: Steven J. Feldman, Venice, FL (US); Peter Glen, Venice, FL (US)

Correspondence Address: BROOKS KUSHMAN P.C., 1000 TOWN CENTER, TWENTY-SECOND FLOOR, SOUTHFIELD, MI, 48075, US

(73) Assignee: XCPT, Inc., Venice, FL (US)

(21) Appl. No.: 11/320,219

(22) Filed: Dec. 28, 2005

(51) Int. Cl. G09G 5/00

(52) U.S. Cl. 345/660

(57) ABSTRACT

An electronic method for re-sizing an object. The method includes selecting an object for re-sizing, dragging a cursor from a first location to a second location to produce a cursor movement, and re-sizing the object based the cursor movement to obtain a re-sized object. The first location can be designated arbitrarily and the second location can be independent of the location of the object.

### BACKGROUND OF THE INVENTION

1. Field of the Invention

One aspect of the present invention relates to a system and method for re-sizing objects.

2. Background Art

Many computer programs allow the user to create and/or insert objects, pictures and/or images, collectively referred to as “objects”, into a document. In many instances, the created or inserted object is not the desired size, and therefore, the user desires to re-size the object.

According to one current proposal, the user can re-size an object by clicking on it via a mouse button, causing a rectangular outline of the object to appear along with handles. The handles are often small black squares. There are usually eight (8) handles on the object, located at the four corners of the object, and at the middle of each of the four sides of the object. The user can then move the mouse cursor and click to select a handle, and then re-size the object by dragging the selected handle. The side handles typically change the object width (without affecting the object height). The top handles typically change the object height (again, without affecting the object width). The corner handles change the height and width of the object together to maintain the same proportions.

The above process often presents several difficulties. For example, in the case of relatively small objects, the handles are hard to select because the handles are too small and close together. Some of the handles may not render, i.e. show where the object is relatively small until the scale of the view is increased so that the object appears larger on the screen. In many cases, a user must scroll a long distance to get to a desired handle, especially when the object is relatively large.

Moreover, if a user wants to change both the height and the width independently, i.e. not proportionately, then the user must select a handle, for example, a side handle, and change one dimension, for example, the width, and then select a second handle, for example, a top or bottom handle and change the other dimension, for example, the height. Thus, changing the size of an object to fit a desired space can involve several steps, which can be time-consuming if there are numerous objects to be re-sized.

In light of the foregoing, a re-sizing system and method is needed for re-sizing objects without the need for accurate hit testing and/or aiming on small and/or non-existent re-sizing handles.

What is also needed is a re-sizing system and method is needed for independently re-sizing the height and width of objects.

A re-sizing system and method is also needed that can handle relatively oversized and undersized objects.

### SUMMARY OF THE INVENTION

One aspect of the present invention is a re-sizing system and method. Another aspect of the present invention is a re-sizing system and method for independently re-sizing the height and width of objects. Yet another aspect of the present invention is a re-sizing system and method for re-sizing relatively oversized and undersized objects. In certain embodiments, the re-sizing systems and methods of the present invention can be implemented through a computer program. In certain embodiments, the systems and methods expend less computer resources, require less interaction accuracy and/or follow human intuition with a higher degree.

According to one embodiment of the present invention, an electronic method for re-sizing an object is disclosed. The method includes selecting an object for re-sizing, dragging a cursor, for example, a mouse cursor, from a first location to a second location to produce a cursor movement, and re-sizing the object based on the cursor movement to obtain a re-sized object. The re-sizing method can produce one or more sizing parameters that can be used to generate the re-sized object. In certain embodiments, the first location can be within the object or on a designated user interface, and the second location can be independent of the object. In certain embodiments, if the first location is a user interface element for example, a pull down or object menu, then dragging the mouse cursor on the menu can initiate the re-sizing procedure.

According to another embodiment of the present invention, an electronic method for re-sizing an object is disclosed. The method includes displaying an object having a width (W) and height (H), receiving a cursor movement for re-sizing the object, calculating a horizontal component (h) and a vertical component (v) based on the cursor movement, and re-sizing the object, for example, incrementally, by adjusting (W) based on (h) and by adjusting (H) based on (v) to obtain a re-sized object.

According to another embodiment of the present invention, a computer system including a computer display for displaying an object that can be re-sized is disclosed. The computer system includes a computer having a central processing unit (CPU) for executing machine instructions and a memory for storing machine instructions that are to be executed by the CPU. The machine instructions when executed by the CPU implement the following functions: displaying an object having a width (W) and height (H), receiving a cursor movement for re-sizing the object, calculating a horizontal component (h) and a vertical component (v) based on the cursor movement, and re-sizing the object, for example, incrementally, by adjusting (W) based on (h) and by adjusting (H) based on (v) to obtain a re-sized object.

### BRIEF DESCRIPTION OF THE DRAWINGS

The features of the present invention which are believed to be novel are set forth with particularity in the appended claims. The present invention, both as to its organization and manner of operation, together with further objects, features and advantages thereof, may best be understood with reference to the following description, taken in connection with the accompanying drawings:

FIG. 1 is an environment, i.e. a computer system, suitable for implementing one or more embodiments of the present invention;

FIG. 2 is a flowchart depicting the steps of a method according to one embodiment of the present invention;

FIGS. 3 and 4 are fragments of a display according to one or more embodiments of the present invention;

FIG. 5 is a fragment of a display depicting the re-sizing of an object according to one or more embodiments of the present invention; and

FIGS. 6 and 7 depict an example of an application of a process of the present invention.

### DETAILED DESCRIPTION OF EMBODIMENTS OF THE PRESENT INVENTION

The words used in the specification are words of description rather than limitation.

“Drag” can refer to the user selecting an object on a display screen, clicking on the object by pressing and holding the mouse button. While the mouse button is down, moving the mouse to a different location constitutes a “drag”. The “drag” ends with the release of the mouse button.

“Object” can mean any user manipulated image, drawing or text, that is part of a document.

“Select” can mean the act of selecting an object. In one embodiment, the user selects an object by moving the mouse cursor on top of the object, and while the cursor is inside the object boundaries, the user clicks the mouse button by pressing it and immediately releasing it.

“User interface” can mean any user manipulated menu, text, button, drawing, or image, that is part of an application or operating system as opposed to part of the document.

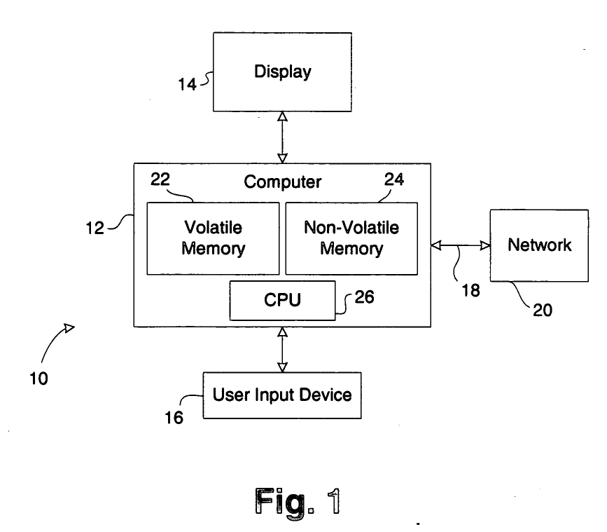

FIG. 1 depicts an environment, computer system 10, suitable for implementing one or more embodiments of the present invention. Computer system 10 includes computer 12, display 14, user interface 16, communication line 18 and network 20.

Computer 12 includes volatile memory 22, non-volatile memory 24 and central processing unit (CPU) 26. Non-limiting examples of non-volatile memory include hard drives, floppy drives, CD and DVD drives, and flash memory, whether internal external, or removable. Volatile memory 22 and/or non-volatile memory 24 can be configured to store machine instructions. CPU 26 can be configured to execute machine instructions to implement functions of the present invention, for example, the re-sizing of objects, images and pictures, otherwise referred to as objects.

Display 14 can be utilized by the user of the computer 12 to view, edit, and/or resize objects. A non-limiting example display 14 is a color display, e.g. a liquid crystal display (LCD) monitor or cathode ray tube (CRT) monitor.

The user input device 16 can be utilized by a user to input instructions to be received by computer 12. The instructions can be instructions for re-sizing objects. The user input device 16 can be a keyboard having a number of input keys, a mouse having one or more mouse buttons, a touchpad or a trackball or combinations thereof. In certain embodiments, the mouse has a left mouse button and a right mouse button. It will be appreciated that the display 14 and user input device 16 can be the same device, for example, a touch-sensitive screen.

Computer 12 can be configured to be interconnected to network 20, the rough communication line 18, for example, a local area network (LAN) or wide area network (WAN), through a variety of interfaces, including, but not limited to dial-in connections, cable modems, high-speed lines, and hybrids thereof. Firewalls can be connected in the communication path to protect certain parts of the network from hostile and/or unauthorized use.

Computer 12 can support TCP/IP protocol which has input and access capabilities via two-way communication lines 18. The communication lines can be an intranet-adaptable communication line, for example, a dedicated line, a satellite link, an Ethernet link, a public telephone network, a private telephone network, and hybrids thereof. The communication lines can also be intranet-adaptable. Examples of suitable communication lines include, but are not limited to, public telephone networks, public cable networks, and hybrids thereof.

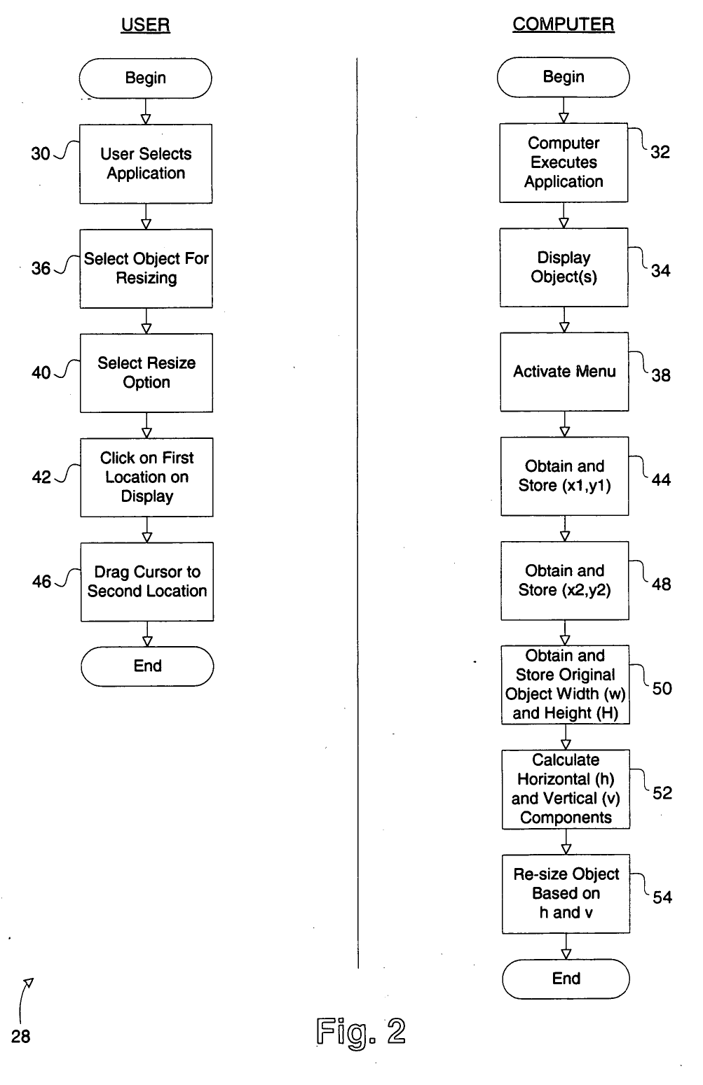

A computer user can utilize computer system 10 to re-size objects. FIG. 2 is a flowchart 28 depicting user steps and computer steps for implementing one or more methods of the present invention. It should be understood that the steps of FIG. 2 can be rearranged, revised and/or omitted, and any step can be carried out by a user, a computer or in combination according to the particular implementation of the present invention.

According to block 30, a user selects an application, for instance, a computer program, for execution on computer 12. In turn, computer 12 executes the computer program, as depicted in block 32. In certain embodiments, the computer program includes functionality for storing objects to volatile memory 22 and/or non-volatile memory 24 and displaying objects on display 14 for viewing and editing by the user.

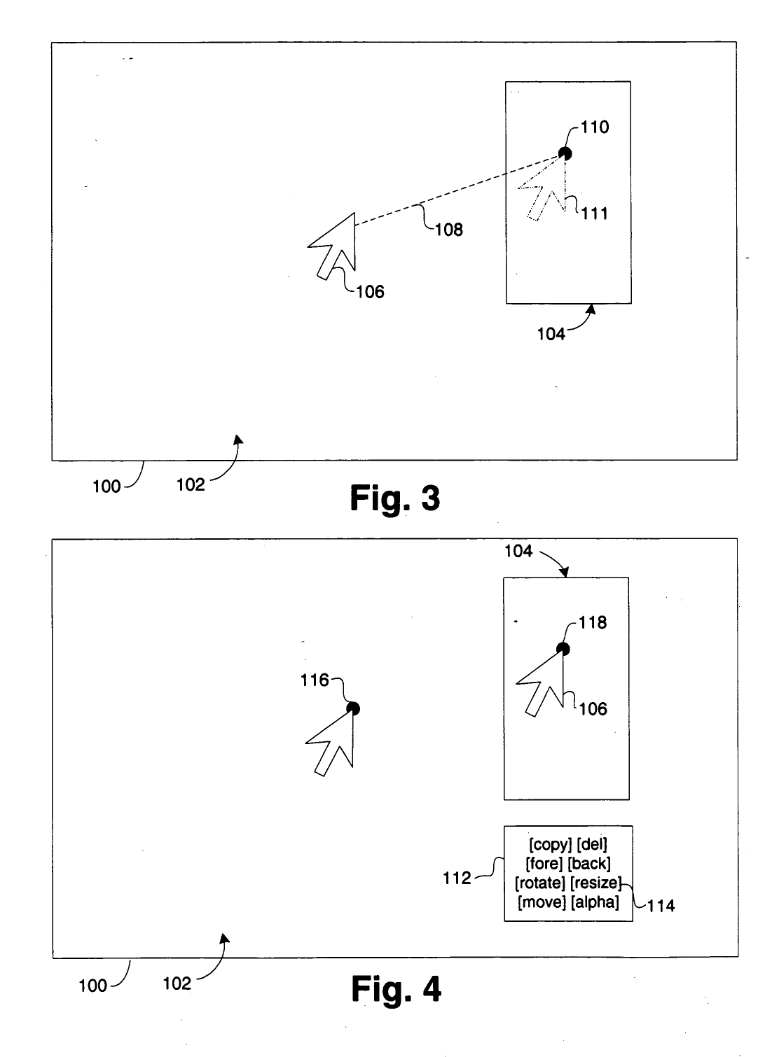

According to block 34 of FIG. 2, one or more objects are displayed on display 14. It should be understood that CPU 26 can execute machine instructions for displaying one or more objects on display 14. FIG. 3 is a portion 100 of display 14 for displaying objects that can be viewed and edited by the user. Portion 100 includes background object 102, otherwise referred to herein as a canvas, and foreground object 104.

It should be appreciated that the canvas and foreground objects of FIG. 3 are one example of the objects that can viewed by utilizing the present invention. In certain embodiments, the canvas is an unmodifiable object that acts as the foundation for superimposition of foreground images. In dental applications, the canvas can be a digital photograph or an X-ray image of the patient's mouth.

In certain embodiments, the user desires to re-size foreground object 104. According to block 36 and FIG. 3, the user selects object 104 by dragging cursor 106 along dotted line 108 to location 110, represented by dotted cursor 111, within the area of object 104. It should be understood that position indications other than cursors can be utilized, for example, pointers, cross hairs, markers, etc. If the user is utilizing a mouse as user input device 16, the user can click a mouse button to select object 104.

In block 38, an object menu is activated by selecting the object for re-sizing. FIG. 4 illustrates object menu 112, which has been activated by the user selecting object 114. Object menu 112 can include a number of options, one of which can be [resize] option 114. Object menu 112 can also point to several other functionalities, for example, [move], [rotate] and [alpha] (a transparency function). According to this embodiment, the re-sizing can be initiated by starting a mouse drag operation on object menu 112. In similar fashion, the aforementioned operations and others can be initiated, thereby, re-size, rotate, move, and transparency can be executed from a centralized area of the computer screen. This benefit can save processing and editing time, pointing to the flexibility of one or more embodiments of the present invention when used in harmony with other user interface elements.

In block 40, the user selects the [resize] option 114, which activates object 104 for re-sizing. In block 42 and FIG. 4, the user clicks on object 114 with cursor 106 at location 118. However, it should be appreciated that the user does not have to click on object 114, and can click outside of object 114, for instance, at location 116 on the display, for purposes of re-sizing object 114. This feature allows the user to re-size relatively small objects without having to manipulate the object itself which is often difficult to because of the relatively small size of the object.

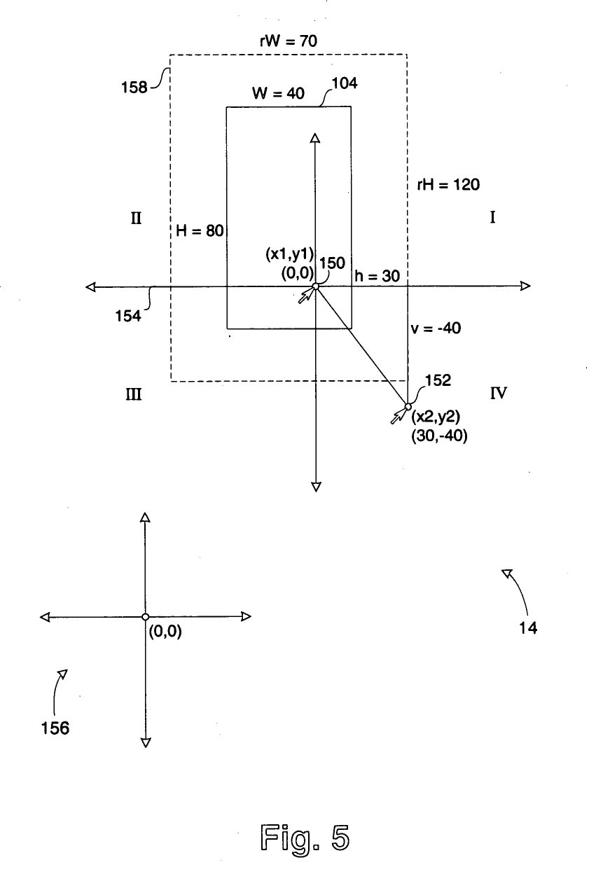

FIG. 5 shows an example of the steps following the [resize] option selection according to one embodiment of the present invention. The user selects or clicks on a first location 150 on display 14. The first location 150 can be represented as an x and y coordinate pair (x1,y1), relative to a coordinate system, for example, a universal or local coordinate system, whereby (x1,y1) can be obtained and stored in memory 22 and/or 24, as represented by block 44.

In block 46, the user then moves the cursor while holding down the mouse button, i.e. dragging the cursor, to a second location 152 on the display 14. The second location 152 can be obtained and stored as an x and y coordinate pair (x2,y2), relative to the same coordinate system as (x1,y1), as depicted in block 48.

According to block 50, the height (H) and width (W) of original object 14 is obtained and stored on computer 12. H and W can be measured as a number of pixels, although other units of measurement, e.g. inches or millimeters can be utilized.

Turning to FIG. 5, (x1,y1) is defined as (0,0) of the coordinate system 154. (x2,y2) is defined as (30,−40) using the same coordinate system 154. It should be understood that coordinates (x1,y1) and (x2,y2) can also be defined relative to a universal coordinate system, for example, coordinate system 156. The use of a certain coordinate system may be desired depending on the computer system and/or computer program used to implement the present invention. According to FIG. 5, the units for coordinate system 154 are pixels, in other embodiments, the units can be inches, millimeters, etc.

In block 52 of FIG. 2, horizontal and vertical components of the cursor movement are calculated. The horizontal component (h) is calculated by the following equation:
h=x2−x1 (1)
Using equation (1), (h) is calculated by subtracting 30 pixels from 0 pixels, thereby yielding a value of 30 pixels for (h). The vertical component (v) is calculated by the following equation:
v=y2−y1 (2)
Using equation (2), (v) is calculated by subtracting −40 pixels from 0 pixels, thereby yielding the value of −40 pixels for (v).

In block 54, object 14 is re-sized based on (h) and (v). In certain embodiments, the following re-sizing rules can be utilized, following the signed adding of coordinates: a positive (h) value results in an increased object width; a negative (h) value results in a decreased object width; a positive (v) value results in a decreased object height; and a negative (h) value results in an increased object height. It should be appreciated that a zero value for (h) and/or (v) results in (W) and/or (H) of the object remaining unchanged.

According to the above re-sizing rules, a functional relationship exists between the re-sized image height (rH), (H) and (v), and an independent functional relationship exists between the re-sized image width (rW), (W) and (h). For example, the following linear relationship can be used to calculate the re-sized image height and width:
rH=H−v (3)
rW=W+h (4)
Using equation (3), (rH) equals 120 pixels since H=80 pixels and v=−40 pixels. Using equation (4), (rW) equals 70 pixels since W=40 pixels and h=30 pixels. The (rH) and (rW) values are used to re-size object 14 to the dimensions reflected by dotted rectangle 158. It should be understood that other functional relationships, for example, exponential, logarithmic, and power law, could be utilized in accordance with calculating the re-sized image height and width.

In certain embodiments, the re-sizing of objects occur in real-time and the results appear instantaneously to the user. As the user drags the cursor while the mouse button is held down, the re-sized object is displayed automatically. The user can make multiple cursor movements while holding the mouse button down. Each of these cursor movements results in a re-sizing of the re-sized object previously generated by the last cursor movement. Upon releasing the mouse button, the user can move the cursor without re-sizing the object any further. When the user desires to re-size the object further, the user simply holds down the mouse button again and moves the cursor.

In certain embodiments, cursor movement in one particular direction increments the object size, while the opposite mouse movement decrements the object size. In the two-dimensional plane, the re-sizing method can influence the object's dimensions in all four quadrants.

The cursor movement depicted on FIG. 5 is a quadrant IV movement, thereby producing a re-sized object having an increased height and width relative to the original object. Other cursor movements are contemplated by the present invention. A quadrant I cursor movement increases the width of the object and decreases the height of the object; a quadrant II cursor movement decreases the width of the object and decreases the height of the object; and a quadrant III cursor movement decreases the width of the object and increases the height of the object. The cursor movements thus described can be referred to as compound movements since there is movement in the vertical and horizontal directions. Advantageously, compound movements result in the independent re-sizing of the height and width of an object.

It should be understood that the cursor movement can be one-dimensional, such that there is cursor movement in only the horizontal or vertical direction. Using coordinate system 154 to illustrate, a cursor movement away from the origin along the positive x-axis causes an increase in the width of the object while the height of the object remains the same; a cursor movement away from the origin along the negative x-axis causes a decrease in the width of the object while the height of the object remains the same; a movement away from the origin along the positive y-axis causes a decrease in the height of the object while the width of the object remains the same; and a movement away from the origin along the negative y-axis causes an increase in the height of the object while the width of the object remains the same.

According to the embodiment shown in FIG. 5, the height and width are re-sized one pixel per each one pixel of cursor movement in the vertical and horizontal directions, respectively. It should be understood that a re-sizing scalar can be used to generate other relationships between the re-sized height and width and cursor movement. The following non-limiting relationship can be utilized:
rH=(H−v)*s (5)
rW=(W+h)*s (6)
wherein s is the re-sizing scalar.

Where (s) is greater than 1, a one unit cursor movement generates a greater than one unit change in the size of the object. Conversely, where (s) is less than 1, a one unit cursor movement generates a less than one unit change in the size of the object. The user can select (s) through a user interface element, such as a object menu or toolbar. Alternatively, the mouse buttons can be used to adjust (s). For example, the left mouse button can be used for cursor dragging while the right mouse button can be clicked to increment the (s) value by one (1). By adjusting (s), the user can adjust the sensitivity of the object re-sizing based on cursor movement, with (s)<1 being decreased sensitivity relative to (s)=1 and (s)>1 being increased sensitivity relative to (s)=1. In certain embodiments, the default value of (s) is 1.

In another embodiment of the present invention, the velocity (vel) of the cursor movement can be factored into the re-sizing of an object. (vel) can be calculated by using the following steps. A first time (t1) is recorded when the cursor is last located at (x1,y1) and a second time (t2) is recorded when the cursor is first located at (x2,y2). A cursor movement time (t) can be calculated by using the following equation:
t=t2−t1 (7)
A cursor movement distance (d) can be calculated by using the following equation:
d=\sqrt{h²+v²} (8)
The velocity of the cursor movement can then be calculated according to the following equation:
vel=d/t (9)
A velocity threshold (vt) can be utilized to determine the effect the velocity has on object re-sizing. For example, if (vel) is greater than (vt), then the (s) value can be greater than 1, and if (vel) is less than (vt), then the (s) value can be 1. A suitable range for the velocity threshold can be determined by empirical studies of user experience. In certain embodiments, the velocity threshold can be subject to user configuration.

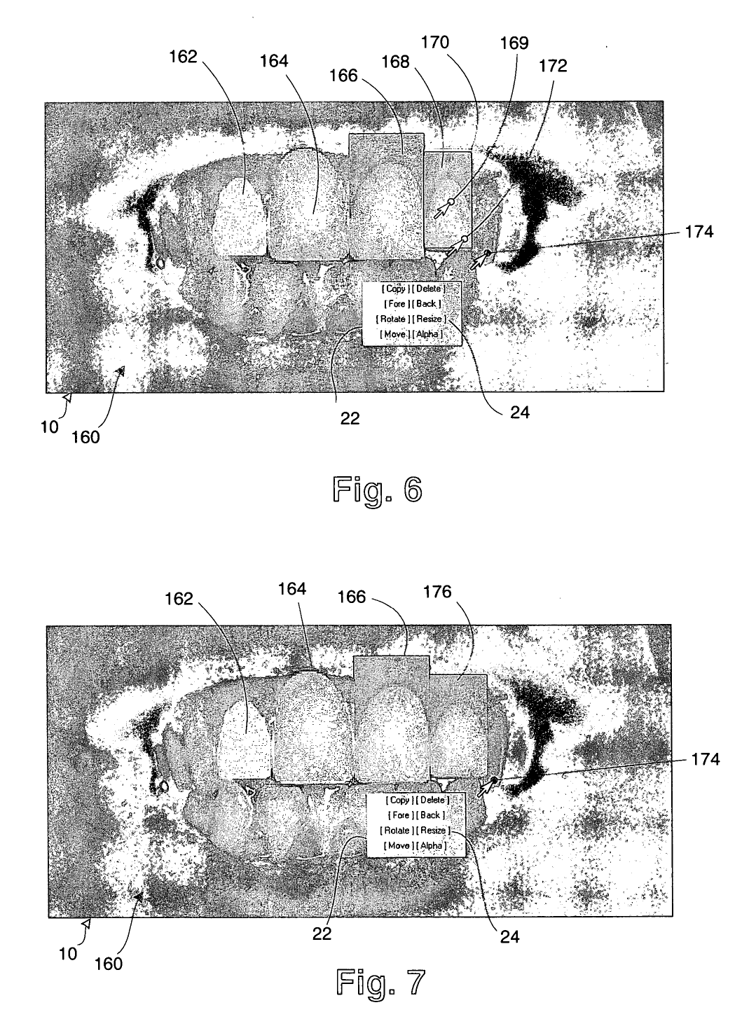

Turning now to FIGS. 6 and 7, an example of a dental application of a process of the present invention is disclosed. In this example, a picture 160 of a patient's mouth is shown on display 14. Picture 160 is shown in the background of display 14. Dental prosthetic images 162, 164, 166 and 168 are shown in the foreground of display 14. The size of dental prosthetic image 168 may not realistically portray the size of the implant with respect to the size of the patient's mouth picture 160. Therefore, it is desired to re-size dental prosthetic image 168. To do so, the user first moves the cursor to a location 169 within the perimeter 170 of prosthetic image 168, and then clicks on the mouse button, thereby generating object menu 22. The user selects the [resize] option 24 to initiate the re-sizing process. The user then clicks on a first location 172 and drags the cursor to a second location 174 to produce a cursor movement for generating the re-sized object 176 of FIG. 7. The process can be easily repeated if the user desires to further re-size the prosthetic image.

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An electronic method for re-sizing an object, the method comprising the steps of:
(a) selecting an object for re-sizing;
(b) dragging a cursor from a first location to a second location to produce a cursor movement, wherein the second location is independent of the location of the object; and
(c) re-sizing the object based the cursor movement to obtain a re-sized object.

2. The electronic method of claim 1 wherein the object is a relatively undersized object.

3. The electronic method of claim 1 wherein the object is a relatively oversized object.

4. The electronic method of claim 1 wherein the first location can be within the object or on a designated user interface element.

5. The electronic method of claim 1 wherein step (c) comprises:
(c) incrementally re-sizing the object as the cursor drags from the first location to the second location.

6. The electronic method of claim 5 further comprising:
(d) displaying the re-sized object.

7. An electronic method for re-sizing an object, the method comprising the steps of:
(a) displaying an object, the object having a width (W) and height (H);
(b) receiving a cursor movement for re-sizing the object
(c) calculating a horizontal (h) and vertical component (v) based on the cursor movement; and
(d) re-sizing the object by adjusting (W) based on (h) and by adjusting (H) based on (v) to obtain a re-sized object.

8. The electronic method of claim 7, wherein the height and width adjustments are independent of each other.

9. The electronic method of claim 7, wherein the cursor movement includes a first cursor position (x1,y1) and a second cursor position (x2,y2).

10. The electronic method of claim 9, further comprising:
(e) determining the horizontal component (h) by subtracting x2 from x1; and
(f) determining the vertical component (v) by subtracting y2 from y1.

11. The electronic method of claim 7, wherein step (d) comprises:
(d1) increasing (W) if (h) is greater than 0;
(d2) decreasing (W) if (h) is less than 0;
(d3) increasing (H) if (v) is less than 0; and
(d4) decreasing (H) if (v) is greater than 0.

12. The electronic method of claim 10, wherein (x1,y1) and (x2,y2) are first and second pixel positions on a computer display, and (h) and (v) are represented as a number of pixels.

13. The electronic method of claim 12, wherein step (d) further comprises:
(d) re-sizing (H) and/or (W) one pixel per pixel of (v) and/or (h).

14. The electronic method of claim 7, further comprising:
(e) receiving a re-sizing scalar (s) for scaling the re-sizing of the object;
(f) calculating a scaled horizontal component based on (s) and (h); and
(g) calculating a scaled vertical component based on (s) and (v).

15. The electronic method of claim 14, wherein step (d) comprises:
(d) re-sizing the object by adjusting (W) based on the scaled horizontal component and by adjusting (H) based on the scaled vertical component to obtain the re-sized object.

16. The electronic method of claim 9, further comprising:
(e) recording a first time (t1) when the cursor is last located at (x1,y1);
(f) recording a second time (t2) when the cursor is first located at (x2,y2);
(g) calculating a cursor movement time (t) by subtracting (t1) from (t2);
(h) calculating a cursor movement distance (d) based on (x1,y1) and (x2,y2); and
(i) determining a cursor movement velocity (vel) by dividing (d) by (t).

17. The electronic method of claim 16, wherein step (d) comprises:
(d) re-sizing the object by adjusting (W) based on (h) and (vel) and by adjusting (H) based on (v) and (vel).

18. A computer system including a computer display for displaying an object that can be re-sized, the computer system comprising:
a computer having a central processing unit (CPU) for executing machine instructions and a memory for storing machine instructions that are to be executed by the CPU, the machine instructions when executed by the CPU implement the following functions:
(a) displaying an object, the object having a width (W) and height (H);
(b) receiving a cursor movement for re-sizing the object;
(c) calculating a horizontal (h) and vertical component (v) based on the cursor movement; and
(d) re-sizing the object by adjusting (W) based on (h) and by adjusting (H) based on (v) to obtain a re-sized object.

19. The computer system of claim 18, the machine instructions for step (d) comprising:
(d1) increasing (W) if (h) is greater than 0;
(d2) decreasing (W) if (h) is less than 0;
(d3) increasing (H) if (v) is less than 0; and
(d4) decreasing (H) if (v) is greater than 0.

20. The computer system of claim 18, the machine instructions for step (d) comprising:
(d) re-sizing the object by adjusting (W) based on (h) and by adjusting (H) based on (v) to obtain the re-sized object wherein the height and width adjustments are independent of each other.
